(19) United States
(12) Patent Application Publication
(10) Pub. No.: US 2026/0046635 A1
(43) Pub. Date: Feb. 12, 2026

(54) ORCHESTRATOR FOR SHARED-SPECTRUM ANTENNAS

(71) Applicant: Vapor IO Inc., Austin, TX (US)

(72) Inventors: Aaron Hinkle, Austin, TX (US); Cole Malone Crawford, Austin, TX (US)

(21) Appl. No.: 19/294,243

(22) Filed: Aug. 7, 2025

Related U.S. Application Data
(60) Provisional application No. 63/680,276, filed on Aug. 7, 2024.

(51) Int. Cl. H04W 16/14; G06V 20/54; H04N 7/18; H04W 52/02

(52) U.S. Cl. CPC H04W 16/14; G06V 20/54; H04N 7/181; H04W 52/0206

(57) ABSTRACT

Provided is a process, including receiving, from a spectrum access system (SAS), an authorization to transmit on a radio spectrum band, wherein the radio spectrum band comprises frequencies between 3550 MHz and 3700 MHz, does not comprise frequencies lower than 3550 MHz, and does not comprise frequencies greater than 3700 MHz; and based on the authorization, instructing a plurality of radio access network (RAN) nodes to transmit communications on the radio spectrum band.

### CROSS-REFERENCE TO RELATED APPLICATIONS

This patent claims the benefit of priority to U.S. Provisional Patent Application No. 63/680,276, entitled “ORCHESTRATOR FOR SHARED-SPECTRUM ANTENNAS,” filed 7 Aug. 2024.

### BACKGROUND

### 1. Field

The present disclosure relates generally to telecommunications and, more specifically, to shared-spectrum network systems.

### 2. Description of the Related Art

Radio access network (RAN) nodes wirelessly connect electronic devices to networks, such as telecommunication networks. Under United States federal regulations, RAN nodes may only operate within certain spectrum bands (i.e., frequency ranges). The Citizens Broadband Radio Service (CBRS), which corresponds to the 3550 MHz to 3700 MHz range, is one such spectrum band. Federal law allows private individuals and organizations to temporarily reserve a portion of CBRS's frequency range in a specified geographic area. Similar initiatives are under consideration or various stages of deployment in other countries.

### SUMMARY

The following is a non-exhaustive listing of some aspects of the present techniques. These and other aspects are described in the following disclosure.

Some aspects include a computerized method including receiving, from a spectrum access system (SAS), an authorization to transmit on a radio spectrum band, wherein the radio spectrum band comprises frequencies between 3550 MHz and 3700 MHz, does not comprise frequencies lower than 3550 MHz, and does not comprise frequencies greater than 3700 MHz; and based on the authorization, instructing a plurality of radio access network (RAN) nodes to transmit communications on the radio spectrum band.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates a system comprising an orchestrator in accordance with some of the present techniques;

FIG. 2 illustrates an example method in accordance with some of the present techniques; and

FIG. 3 illustrates an example computing device by which the described techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of telecommunications. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some telecommunications systems, such as shared-spectrum systems, including the Citizens Broadband Radio Service (CBRS), allow users to reserve bandwidth for private use, e.g., for a day, in a specified geographic area, at a specified broadcast strength, independent of a cellular carrier. Many cellular networks, in contrast, reserve spectrum for use by the cellular carrier and its customers. Such decentralized allocation of spectrum may be coordinated by a spectrum access system (SAS), which may have an application programming interface (API) by which broadcasters reserve spectrum for durations of time, like 24 hours. To operate, a radio (e.g., a radio access network (RAN) node) may need someone or something to perform the bandwidth-reservation process by interfacing with a SAS via the SAS's API and then configure the radio according to the allocation.

Such reservation and configuration can be cumbersome. Many radios configured to operate on CBRS's spectrum band (3550 MHz to 3700 MHz) are not configured for compatibility with U.S.-based CBRS SASs—e.g., because the radios are produced overseas, often with an eye toward minimizing cost. And at least for similar reasons, configuring CBRS-enabled radios to operate on the reserved frequency, at the authorized power level and azimuth, etc. can present technical challenges. These challenges are exacerbated as the number of such radios are expected to proliferate to more than 100, or more than 1,000 in a city (e.g., within a circle of 10 square kilometers), and each such radio may need to specify different parameters to the SAS to reserve bandwidth, and in some cases, it may be desirable to coordinate such reservations among the radios in a metro area or other geographic region.

Some embodiments are expected to mitigate these problems (or others) by providing a system comprising an orchestrator, which may be an application (or other program) that communicates with a SAS to obtain authorization for a plurality of RAN nodes to operate on one or more spectrum bands. After obtaining authorization from the SAS (and/or denial thereof), the orchestrator may enable, disable, and/or alter power level(s) of RAN node(s) to efficiently allocate service coverage. This configuration (and/or other features describe herein) (a) enables RAN nodes of various types (including those not designed for use in the United States) to achieve compatibility with a variety of network architectures, systems, and software components, including CBRS SASs and (b) minimize unnecessary power consumption, among other benefits.

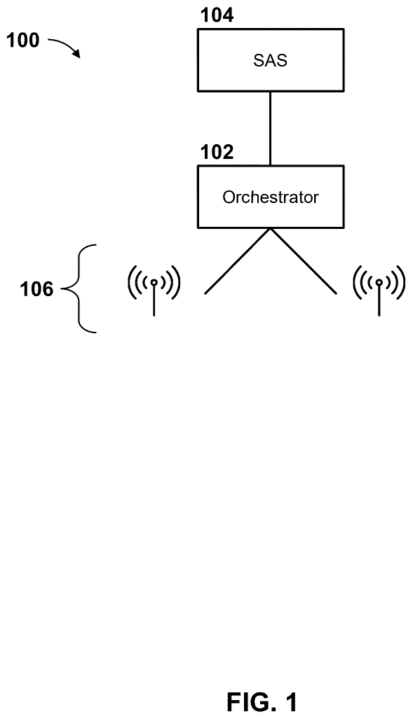

FIG. 1 depicts an example of a telecommunications system 100. The system 100 may include, among other elements, an orchestrator 102 operatively connected to a spectrum access system (SAS) 104 and a plurality of RAN nodes 106. In some embodiments, the orchestrator 102 may be an application layer (e.g., implemented as an application or program) wrapped around each of the plurality of RAN nodes 106, e.g., logically residing between the SAS and the RAN's element management system. The orchestrator 102 may communicate with the SAS 104 on behalf of the RAN nodes 106, in order to, for example, reserve frequency band(s) or obtain authorization for the RAN nodes 106 to operate on the reserved frequency band(s), at specified broadcast strength, for specified durations of time, in specified geographic locations, at a specified azimuth, altitude, and elevation in some cases. This configuration may facilitate radio-SAS compatibility or improve the efficiency with which the RAN nodes 106 can be configured to operate on CBRS frequencies, among other benefits.

In some cases, the orchestrator 102 may have parameters for API request to a SAS hard-coded into the orchestrator 102, or some such parameters may be sensed, e.g., with a geolocation sensor (e.g., based on satellite signals or triangulating from signals from cell towers or other broadcast signals), compass, altimeter, near-field communication sensor, etc.

In some embodiments, the SAS 104 manages spectrum allocation, e.g., over a region, the United States, or other geographic areas, for instance for those using the same SAS, or among all SASs. The SAS 104 may expose an API for communicating outputs and receiving API requests, e.g., via a network, like the Internet. SASs may be managed by private companies; examples including include Google® and Federated Wireless®.

The SAS 104 may authorize a radio to operate on a specific frequency band for a fixed period of time. For example, the SAS 104 may allow a user to reserve a 10 MHz spectrum block for 24 hours (e.g., starting at midnight local time). When the SAS 104 “checks out” a spectrum block to one or more radios, the SAS 104 may communicate, to the radio (or, in the case of the system 100, the orchestrator 102), the frequency range of the spectrum block and/or a geographic area in which the radio is authorized to operate. In some cases, the reservation is according to 47 C.F.R. Part 96, Subpart F, the contents of which are hereby incorporated by reference.

Although the present disclosure references CBRS and U.S.-based SASs, it is contemplated that the present disclosure applies internationally. For example, instead of CBRS and/or its corresponding frequency range, authorization may be obtained to transmit in a frequency range designated by another nation or organization as available for public use. For example, the present disclosure contemplates transmission on any shared-spectrum frequency range, regardless of location or country.

Additionally, although the present disclosure may refer to “a” SAS or “the” SAS, it is contemplated that the SAS 104 shown in FIG. 1 may, in some embodiments, represent two or more SASs. In some embodiments, the orchestrator 102 may reserve spectrum blocks from multiple SAS providers—e.g., reserving the same block at both to reduce the risk of destructive interference from a third-party radio operating on a same or similar frequency.

The RAN nodes 106 may be operatively connected to the orchestrator 102, one or more devices, such as user equipment (UEs), and/or a core network. The term “RAN nodes” is used broadly to include any radios capable of receiving and transmitting CBRS frequencies (or corresponding frequencies in countries other than the US). The RAN nodes 106 may be configured to operate, without limitation (which is not to suggest that other lists are limiting), on CBRS frequencies (e.g., from 3550 MHz to 3700 MHz).

The RAN nodes 106 may be configured in accordance with the Open RAN Specifications, the contents of which are hereby incorporated by reference. Open RAN specified operations may facilitate interoperability between RAN components, such as radios and basebands. Any of the RAN nodes 106 may, for example, include firmware or software that facilitates operation in accordance with Open RAN standards or architectures (or according to other approaches). The combination of the orchestrator 102 with Open RAN-enabled RAN nodes 106 may increase interoperability, including the case with which RAN nodes (and RAN node components) can be mixed and matched without defeating compatibility with the SAS 104, for example.

In some embodiments, the RAN nodes 106 may be standalone, static (e.g., non-mobile) structures or they may be mobile or attached to other structures. In other embodiments, such as some edge-computing examples discussed in more detail below, the RAN nodes 106 may be physically attached to other structures, such as infrastructure in a city. In some embodiments, one or more of the RAN nodes 106 may be standalone structures while one or more other RAN nodes 106 are attached to other structures.

The orchestrator 102 may be a software application (e.g., running in an operating system, or as firmware or a driver) that communicates with the SAS 104 on behalf of the RAN nodes 106. In some embodiments, the orchestrator 102 may (a) request bandwidth from the SAS 104, (b) receive a response from the SAS 104, and/or (c) provide instructions to one or more of the RAN nodes 106 based on the response from the SAS 104, among other operations. These three steps are now discussed in additional detail. In some cases, the request and configuration operations may accord with the API described at the URL https://cloud.google.com/spectrum-access-system/docs (including all product documentation under this URL, e.g., overview, roles-and-permissions, etc.) as recorded by the Internet Archive most recently before the filing of this application, the contents of which are hereby incorporated by reference.

In some embodiments, the orchestrator 102 may request bandwidth from the SAS 104 by transmitting a communication to the SAS 104, e.g., via the RAN or via another network interface, such as a wired connection to a network. In some examples, the request is transmitted about every 24 hours, depending, for example, on how often the SAS 104 requires users to re-reserve spectrum blocks. The request may include information regarding the radio antenna(s) for which spectrum access is requested. The radio information may include information regarding radio location(s) and/or radio azimuth(s), for example. The request may further include the frequency range(s) of the requested spectrum block(s) and/or the geographic region(s) in which spectrum reservation is desired. The orchestrator 102 may request a geographic region based on (a) a RAN node being physically located in the geographic region and/or (b) the geographic region corresponding to a desired service area, for example. The request may be communicated by the orchestrator 102 to the SAS 104 via the SAS's API. Examples of installation parameters for a device may include the following:
“latitude”: number,
“longitude”: number,
“height”: number,
“heightType”: enum (HeightType),
“horizontalAccuracy”: number,
“verticalAccuracy”: number,
“indoorDeployment”: boolean,
“antennaAzimuth”: integer,
“antennaDowntilt”: integer,
“antennaGain”: integer,
“eirpCapability”: integer,
“antennaBeamwidth”: integer,
“antennaModel”: string

The orchestrator 102 may receive a response from the SAS 104. The response may comprise information regarding the reserved spectrum block(s) and the geographic areas for which the spectrum blocks have been reserved. The orchestrator 102 may perform any of several operations (including any combination thereof) based on the SAS's response. Examples of a device gran format may include the following:

```
{
  “maxEirp”: number,
  “frequencyRange”: {
    object (FrequencyRange)
  },
  “state”: enum (GrantState),
  “channelType”: enum (ChannelType),
  “moveList”: [
    {
      object (DpaMoveList)
    }
  ],
  “expireTime”: string
}
```

For example, the orchestrator 102 may enable or disable a RAN node 106. In some embodiments, the orchestrator 102 receives an indication from the SAS 104 that a RAN node 106 is authorized to operate on a certain frequency band. In response, the orchestrator 102 may instruct the RAN node 106 to activate its antenna—e.g., begin transmitting and/or receiving radio signals. In other cases, the orchestrator 102 may receive an indication from the SAS 104 that the RAN node 106 is not authorized to operate (e.g., because all applicable spectrum bands in the RAN node's location have been reserved). In response, the orchestrator 102 may instruct the RAN node 106 to disable its antenna—e.g., cease transmitting and/or receiving radio signals.

In some embodiments, the orchestrator 102 enables and/or disables one or more first RAN nodes based on both (a) the indication from the SAS 104 and (b) characteristics of one or more second RAN nodes. For example, the orchestrator 102 may determine that activating both (i) one or more first RAN nodes and (ii) one or more second RAN nodes would result in redundant coverage and/or destructive interference. Accordingly, the orchestrator 102 may dynamically enable/disable RAN nodes in order to avoid redundant coverage and/or limit destructive interference.

As another example, in some embodiments, the orchestrator 102 instructs a RAN node to increase or decrease its antenna's power level—e.g., increase or decrease the distance over which its signal propagates. For example, in some embodiments, the orchestrator 102 determines, based on a communication (e.g., response) from the SAS 104, a geographic area in which a RAN node is authorized to operate. The orchestrator 102 may (a) increase the RAN node's power level to improve the RAN node's coverage of the geographic area or (b) decrease the RAN node's power level—e.g., to reduce (or eliminate) signal propagation beyond the geographic area.

The orchestrator 102 may adjust a RAN node's power level based (alternatively or additionally) on other factors as well. In some embodiments, the orchestrator 102 takes into account locations, azimuths, and/or other characteristics of multiple RAN nodes when setting a certain RAN node's power level. For example, the orchestrator 102 may dynamically adjust a plurality of RAN nodes' power levels to provide adequate coverage to a geographic area (e.g., a service area) while optimizing for power efficiency. As another example, the orchestrator 102 may increase a first RAN node's power level and/or decrease a second RAN node's power level to reduce redundant coverage and/or destructive interference. These are merely examples for purposes of illustration (which is not to suggest other text is limiting), and the orchestrator 102 may modify a RAN node's power level in a variety of circumstances and based on a variety of factors. Additionally, embodiments are not limited to those that provide these advantages.

In some embodiments, the system 100 may include elements not shown in FIG. 1. For example, depending on a RAN node's architecture (e.g., whether the RAN node is configured in accordance with Open RAN), an element management system (EMS) may be schematically disposed between the orchestrator 102 and the RAN node. The EMS may mediate communications between the orchestrator 102 and the RAN node. This is merely an example (which is not to suggest other text is limiting), and the system 100 may include additional elements not shown.

Any or all aspects of the system 100 may be implemented in, or in coordination with, a variety of applications, such as edge computing applications. One example is traffic control. In some embodiments, traffic data (e.g., video feeds of traffic subject to object detection for cars) is collected at or near traffic control signals (e.g., stoplights and crosswalk signs) and transmitted, via CBRS and the RAN nodes, to a traffic control system for processing. The traffic control system may operate the traffic control signals to optimize the flow of traffic, reduce delays, and protect driver and pedestrian safety, to name a few examples.

The system 100 may be used for application to traffic control systems (in addition to other embodiments). A camera may be co-located with the RAN, e.g., integrated with in, and configured to communicate images, like video, or results of local inference, via the RAN. The network over which traffic images/videos are transmitted for processing may involve considerable bandwidth given (a) the large density of stoplights and other traffic controls in a typical municipality and (b) the amount of data transmitted per second (i.e., bitrate) from each camera. Moreover, traffic control systems may have low latency due to the time-sensitive nature of traffic control. Some embodiments are expected to achieve these benefits. (However, embodiments are not limited to those that provide these advantages.) In contrast, many other networks operated by mobile network operators (MNOs) typically have insufficient bandwidth and/or relatively high latency.

In some embodiments, some or all of the RAN nodes 106 may be affixed and/or otherwise operatively coupled to respective traffic control signals (e.g., stoplights and/or crosswalk signals). Additionally, cameras (and/or other sensors) may be affixed and/or operatively coupled to the traffic control signals. The cameras may capture images/videos of respective traffic intersections, streets, highways, crosswalks, or sidewalks, to name a few non-limiting examples (which is not to suggest that other examples are limiting). The videos captured by the cameras may be transmitted (e.g., streamed/uploaded) by the respective RAN nodes 106 over CBRS.

The videos may be processed by a traffic control system. In some embodiments, the traffic control system is embodied on one or more computer systems physically located proximate to (e.g., within a same municipality as) the RAN nodes 106—for example, to minimize latency. In some embodiments, the computer systems are located within range of the RAN nodes 106 such that the traffic control system can receive data directly from the RAN nodes 106—e.g., without transmission through a “middleman” such as a core network.

The traffic control system can comprise one or more computer programs. In some embodiments, the traffic control system comprises a trained artificial intelligence (AI) model. The AI model can be trained using any suitable technique, including supervised learning, unsupervised learning, or reinforcement learning. The AI model may be optimized to minimize traffic congestion and maximize driver and pedestrian safety, to name two non-limiting examples.

In some embodiments, the traffic control system makes a traffic control decision based on one source of input data (e.g., one image or video). For example, if the traffic control system determines that an automobile is stopped at an intersection, the traffic control system may instruct a corresponding traffic light to permit the automobile to proceed through the intersection (i.e., turn green). Similarly, if the traffic control system determines that a pedestrian is waiting at a crosswalk, the traffic control system may instruct a corresponding traffic light (and/or a crosswalk signal) to permit the pedestrian to enter the crosswalk.

In some embodiments, the traffic control system makes a traffic control decision based on multiple sources of input data (e.g., multiple images or videos). For example, the traffic control system may simultaneously or concurrently receive multiple video feeds (e.g., from the RAN nodes 106 via CBRS) and make one or more traffic control decisions in real time based on the received video feeds. For example, the traffic control system may alter one or more traffic signals in order to relieve traffic congestion, for instance, by increasing/changing a duration of one or more green-light cycles in response to determining that congestion is above a threshold or has increased on a road, or vice versa.

As discussed, in some embodiments, the traffic control system transmits instructions to one or more traffic control signals based on information received from the RAN nodes 106. These instructions may cause the traffic control signal(s) to perform any operation they are configured to perform, such as changing a traffic light's color to red, yellow, or green; activating a crosswalk signal; or deactivating a crosswalk signal, to name a few non-limiting examples. In some embodiments, the instructions are transmitted from the traffic control system to the RAN nodes 106 via CBRS. However, it is contemplated that the instructions can be transmitted (alternatively or additionally) using one or more other methods, such as via a wired connection.

The traffic-control embodiment described herein is only one non-limiting embodiment (which is not to imply other embodiments are limiting) in which aspects of the system 100 may be implemented. In other example implementations, the RAN nodes 106 may be configured to transmit data to and/or from gaming systems (e.g., for cloud-based gaming), hospitals (e.g., for patient monitoring), automobiles (e.g., to direct autonomous or semi-autonomous automobiles), industrial equipment (e.g., for transmission of maintenance information), smart homes, mobile devices, or other computing devices.

Some embodiments may locally cross-connect networks with techniques like those described in U.S. patent application Ser. No. 17/956,714, titled DISTRIBUTED PROCESSING FOR DETERMINING NETWORK PATHS, filed Sep. 29, 2022, the entire contents of which are hereby incorporated by reference. Some embodiments may manage computing equipment upon which the data conveyed over the wireless connections herein is processed with techniques like those described in U.S. Pat. No. 11,349,701, titled DATA CENTER MANAGEMENT WITH RACK-CONTROLLERS, filed Jun. 11, 2019, the entire contents of which are hereby incorporated by reference. Some embodiments may execute workload on such data (e.g., artificial intelligence inference, such as computer vision classifiers) in computing equipment housed in edge-based data centers like those described in U.S. patent application Ser. No. 17/082,869, titled MODULAR DATA CENTER, filed Oct. 28, 2020, the entire contents of which are hereby incorporated by reference. Some embodiments may schedule workload on such computing equipment with techniques like those described in U.S. Pat. No. 11,838,183, titled AUTONOMOUS DISTRIBUTED WORKLOAD AND INFRASTRUCTURE SCHEDULING, filed Mar. 8, 2021, and in U.S. patent application Ser. No. 17/863,264, titled REDUCING THE ENVIRONMENTAL IMPACT OF DISTRIBUTED COMPUTING, filed Jul. 12, 2022, the entire contents of each of which are hereby incorporated by reference.

In some embodiments, the orchestrator 102 comprises a machine learning (ML) or artificial intelligence (AI) model. The model, like the orchestrator 102, may be deployed in a centralized or distributed architecture. The model may be trained to optimize operational parameters of a plurality of RAN nodes, including, but not limited to, transmission power, antenna azimuth, tilt, beamforming configurations, and/or any other RAN node parameters discussed herein.

The training and optimization process may be directed toward achieving specific network performance objectives, such as minimizing overall power consumption, maximizing geographic coverage, improving signal quality, or maintaining desired levels of user throughput and connectivity reliability. The machine learning model may be trained using historical and/or real-time data collected from RAN nodes, user equipment (UE), and/or other network entities.

Training data for the model may include, for example, geolocation data, signal strength measurements (e.g., RSRP, SINR), handover statistics, user density patterns, terrain and building obstructions, historical power settings, and/or network traffic demand variations over time. The model may be configured to infer relationships between these input features and one or more performance metrics. In some embodiments, the model is trained on a loss function that incentivizes energy efficiency and/or a loss function that incentivizes coverage breadth.

The training process may use supervised, unsupervised, or reinforcement learning techniques, or combinations thereof. In some embodiments, a reinforcement learning agent may receive feedback in the form of network performance rewards or penalties to iteratively improve its policy for adjusting RAN parameters.

At the inference stage, the trained model can take as input any type of data (e.g., RAN node parameters) on which the model was trained, or any other data type the model is configured to accept.

The trained model may output control directives (e.g., communications/instructions to one or more RAN nodes) specifying updated configurations for RAN node(s). For instance, the model may instruct a reduction in transmission power during off-peak hours to conserve energy, while dynamically adjusting azimuth angles and antenna tilt to fill potential coverage gaps.

As another example, the model may identify underperforming sectors and recommend increased power or azimuth realignment to enhance signal quality in densely populated regions (e.g., high-traffic areas in traffic-control embodiments). These instructions/communications may be transmitted and/or executed automatically.

In another example, the trained machine learning model causes an increase in a first amount of power supplied to a first RAN node and causes a decrease in a second amount of power supplied to a second RAN node of the plurality of RAN nodes.

The model may continuously retrain or fine-tune itself using new data streams to adapt to changing environmental and user conditions, for example.

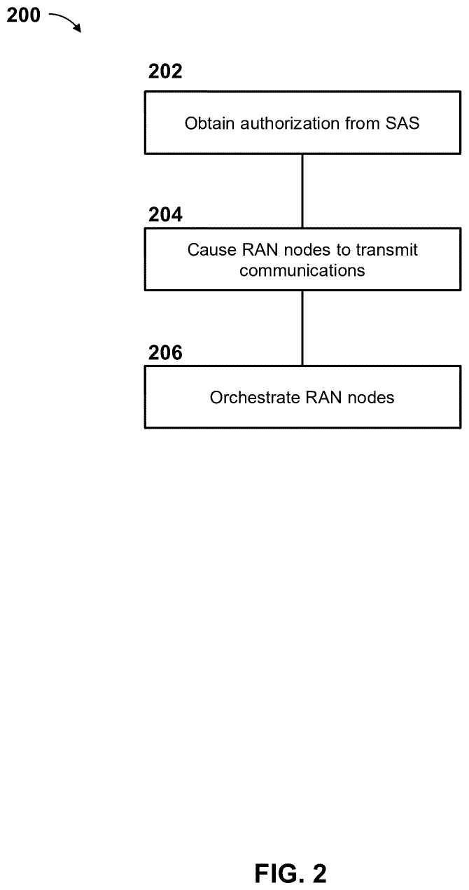

FIG. 2 is a flowchart that illustrates an exemplary method 200 in accordance with embodiments of the present techniques.

At step 202, authorization is obtained from a SAS. The authorization may be authorization to transmit communications, such as radio communications. The authorization may correspond to a frequency range. The frequency range may be within a broader frequency range designated by a government for use by the public. The broader frequency range may, in the United States, be the CBRS.

The authorization obtained at step 202 may be obtain from one SAS or multiple SASs. The authorization may be applicable to one radio/RAN node or may be applicable to multiple radios/RAN nodes. The frequency range may be a 10 MHz band or block of frequencies.

At step 204, RAN nodes are caused to transmit communications. The RAN nodes may be caused to transmit the communications by an orchestrator, such as the orchestrator 102 discussed with reference to FIG. 1. However, embodiments herein are not so limited. The orchestrator may transmit instructions to one or more RAN nodes that cause the RAN nodes to transmit communications.

The RAN nodes may be collocated or otherwise operatively coupled to one or more other devices or components. For example, the RAN nodes may be operatively coupled to cameras and/or other sensors.

At step 206, the RAN nodes are orchestrated—e.g., by the orchestrator 102 discussed with respect to FIG. 1. In some embodiments, amount(s) of power supplied to one or more RAN nodes are varied. Power levels may be dynamically varied to optimize radio coverage, use power efficiently, and/or achieve other objectives. Other antenna/RAN node characteristics may be varied for the same or other reasons. For example, antenna azimuths of the RAN nodes may be adjusted to modify coverage area.

The steps discussed with respect to FIG. 2 are not limiting. For example, the method 200 may omit steps or may include additional steps, such as steps discussed herein with respect to traffic control and/or other embodiments.

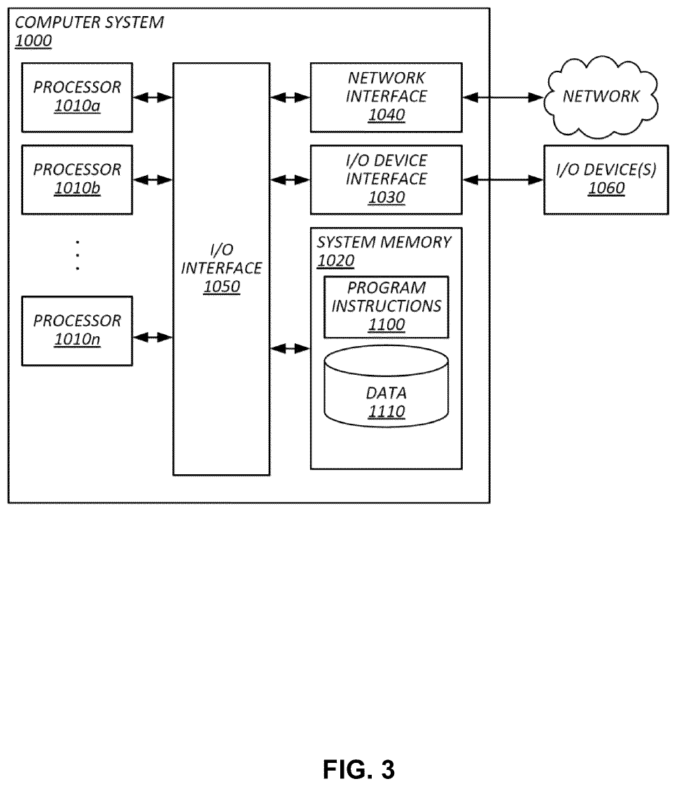

FIG. 3 is a diagram that illustrates an exemplary computing system 1000 in accordance with embodiments of the present techniques, which may be used to perform some or all of the above-described computational acts. A single computing device is shown, but some embodiments of a computer system may include multiple computing devices that communicate over a network, for instance in the course of collectively executing various parts of a distributed application. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A computerized method comprising:
receiving, from a spectrum access system (SAS), an authorization to transmit on a radio spectrum band,
wherein the radio spectrum band comprises frequencies between 3550 MHz and 3700 MHz, does not comprise frequencies lower than 3550 MHz, and does not comprise frequencies greater than 3700 MHz; and
based on the authorization, causing a plurality of radio access network (RAN) nodes to transmit communications on the radio spectrum band.

2. The computerized method of claim 1, wherein the communications comprise videos captured by traffic cameras.

3. The computerized method of claim 2, wherein the videos are transmitted to a traffic control system.

4. The computerized method of claim 3, wherein the transmission of the videos to the traffic control system causes the traffic control system to make a traffic control decision.

5. The computerized method of claim 4, wherein the traffic control decision comprises altering a state of a stoplight or crosswalk signal based on at least one of the videos.

6. The computerized method of claim 4, wherein the traffic control decision comprises changing a length of a stoplight cycle based on the videos.

7. The computerized method of claim 1, further comprising:
determining that a first RAN node of the plurality of RAN nodes and a second RAN node of the plurality of RAN nodes are providing redundant geographic coverage; and
based on the determination, causing an amount of power supplied to the first RAN node to be reduced.

8. The computerized method of claim 1, further comprising:
determining that a first RAN node of the plurality of RAN nodes and a second RAN node of the plurality of RAN nodes are destructively interfering with one another; and
based on the determination, causing an amount of power supplied to the first RAN node to be reduced.

9. The computerized method of claim 1, further comprising:
determining that a first RAN node of the plurality of RAN nodes and a second RAN node of the plurality of RAN nodes are destructively interfering with one another; and
based on the determination, (a) causing an amount of power supplied to the first RAN node to be reduced and (b) causing an amount of power supplied to the second RAN node to be increased.

10. The computerized method of claim 1, wherein the authorization is received from the SAS via an element management system (EMS).

11. The computerized method of claim 1, further comprising:
receiving, from a second SAS, a second authorization to transmit on a spectrum band of the Citizens Broadband Radio Service (CBRS); and
based on the second authorization, causing a second plurality of RAN nodes to transmit second communications on the spectrum band of the CBRS.

12. The computerized method of claim 1, further comprising steps for facilitating traffic management.

13. The computerized method of claim 1, further comprising steps for varying power levels of the plurality of RAN nodes using a machine learning model.

14. The computerized method of claim 1, further comprising:
causing, by a trained machine learning model, an increase in a first amount of power supplied to a first RAN node of the plurality of RAN nodes; and
causing, by the trained machine learning model, a decrease in a second amount of power supplied to a second RAN node of the plurality of RAN nodes.

15. The computerized method of claim 14, wherein the trained machine learning model is trained on a first loss function that incentivizes maximization of RAN node coverage area and trained on a second loss function that incentivizes RAN node power efficiency.

16. One or more tangible, non-transitory, machine-readable media storing instructions that, when executed by a computer system, effectuate operations comprising:
receiving, from a spectrum access system (SAS), an authorization to transmit on the Citizens Broadband Radio Service (CBRS);
based on the authorization, causing a plurality of radio access network (RAN) nodes to transmit communications on the CBRS;
determining that a first RAN node of the plurality of RAN nodes and a second RAN node of the plurality of RAN nodes are providing redundant geographic coverage; and
based on the determination, causing an amount of power supplied to the first RAN node to be reduced.

17. The media of claim 16, wherein the power supplied to the first RAN node is caused to be reduced by a machine learning model trained at least in part on a loss function that incentivizes maximization of RAN node coverage area.

18. The media of claim 16, wherein the communications comprise videos captured by traffic cameras.

19. The media of claim 18, wherein the videos are transmitted to a traffic control system.

20. A computerized method comprising:
receiving traffic video data from a plurality of radio access network (RAN) nodes,
wherein the traffic video data is received via radio transmission in a frequency range between 3550 MHz and 3700 MHz, inclusive, and
wherein the plurality of RAN nodes are caused to transmit the traffic video data by an orchestrator based on an authorization received from a spectrum access system (SAS); and
based on the traffic video data, causing a change in state of a plurality of traffic signals.
